(19) United States
(12) Patent Application Publication
(10) Pub. No.: US 2007/0054009 A1
(43) Pub. Date: Mar. 8, 2007

(54) Soy processing method using specific enzyme, processed soy power and processed soy liquid

(75) Inventor: Edson Chang, Sao Paulo (BR)

Correspondence Address: BACON & THOMAS, PLLC, 625 SLATERS LANE, FOURTH FLOOR, ALEXANDRIA, VA, 22314, US

(73) Assignee: Brasfanta Industria e Comercio Ltda., Sao Paulo (BR)

(21) Appl. No.: 11/512,253

(22) Filed: Aug. 30, 2006

(30) Foreign Application Priority Data
Sep. 6, 2005 (BR) PI 0503756-5

(51) Int. Cl. A23L 1/20

(52) U.S. Cl. 426/46

(57) ABSTRACT

The present invention refers to a method of processing soy by using specific enzyme, in other words, by using a pectinase produced by microorganisms from Aspergillus genera (such as pectinmethylesterase enzyme, produced by the microorganism Aspergillus oryzae; or the enzymes pectintranseliminase, polygalacturonase and pectinesterase, produced by the microorganism Aspergillus niger; or betagluconase(endo-1,3(4)-), produced by the microorganism Aspergillus aculeatus), which is capable of efficiently producing a processed soy powder and/or liquid with substantially no unpleasant odor, characteristic of products derived from soy, and an ameliorated digestion-absorption coefficient for human body, using soy in its integral form, in other words, utilizing all nutrients present in soy. It also refers to a processed soy powder and/or liquid with substantially no unpleasant odor, characteristic of products derived from soy, and an ameliorated digestion-absorption coefficient for human body, using soy in its integral form.

### TECHNICAL FIELD

The present invention refers to a soy processing method using specific enzyme, and in particular, soy processing method, which comprehends the stage of efficiently separating soy cells from one another using pectinase produced by microorganisms from the Aspergillus genera (such as pectinmethylesterase, produced by the microorganism Aspergillus oryzae; or the enzymes pectintranseliminase, polygalacturonase and pectinesterase, produced by the microorganism Aspergillus niger; or beta-gluconase(endo-1,3(4)-), produced by the microorganism Aspergillus aculeatus). Besides this, the present invention refers to processing soy powder and/or liquid obtained by the referred method.

### TECHNIQUE FUNDAMENTALS

Soy is a plant that belongs to the leguminous family, in other words, beans, lentil, chickpea, pea and, it stands out for having lots of highly nutritional protein, fibers, some vitamins and minerals, phytosterol, saponins, lecithin and for having an excellent lipid profile (small amount of saturated fatty acids, large amounts of mono and polyunsaturated fatty acids—specially in Omega-6 and Omega-3, keeping an excellent proportion between these two). Also, contains, a class of phytohormones (hormones with vegetable origin) known as isoflavones.

In addition to being highly nutritious nourishment, can be consumed in life's different stages, soy consumption is also associated with prevention of several diseases, such as cardiovascular diseases, cancer, diabetes, obesities, osteoporoses and yet still, with relieving menopauses' symptoms. Concerning cardiovascular diseases, several of soy's nutrients (isoflavones, proteins, fibers, fatty acids, phytosterols, and saponines) have beneficial effects in human body, such as reducing blood levels of cholesterol, triglycerides and LDL (low density lipoprotein—responsible for accumulating cholesterol inside blood vessels) and raising HDL blood levels (High density lipoprotein, known as “good cholesterol”), besides reducing arterial blood pressure in individuals with hypertension and, having an anti-oxidant effect.

Even though soy is excellent nourishment for different groups of individuals (children, adolescents, athletes and elder) women are the main beneficiaries with soy consumption. Isoflavones, as well as protein present in this nutriment, help preserve osseous mass, since it reduces calcium loss that occurs in the human body, helping prevent osteoporosis. Isoflavones also help balance the activity of the estrogen hormone in women's bodies, therefore assuaging menopause symptoms.

Another characteristic associated with soy is the reduction in probability of developing cancer. Several researchers still analyze the efficacy of soy in preventing this disease. However, some factors lead to believe that soy consumption can generate positive results. In Asian countries, where there is major soy consumption, breast cancer rate is from five to eight times lower when compared to other countries.

Soy has also been described for containing anti-nutritional factors that limit its usage. The most important and extensively investigated of the anti-nutritional factors are the trypsin inhibitors. These anti-nutritional factors present specificity for inhibiting photolytic enzymes and, consequently, reducing nutriment protein digestion. Therefore, to enhance soy and its products nutritional value, thermal processing is required to inactivate them.

Besides the above cited, soy has the disadvantage of having a very hard tissue, which makes its digestion-absorption coefficient for the human body, very small, whence the importance of processing soy to be used in food industry.

Another very important factor, is the fact that, when soy cells are burst, an enzyme known as lipoxigenase (present in soy) encounters several fatty acids (polyunsaturated), forming volatile compounds, which are the main responsible for the unpleasant odor found in products derived from soy.

In the past, efforts where made to use soy powder mechanically acquired by pulverizing soy or soy pie. However, since soy cells are destroyed during pulverizing operation, soy powder has an unpleasant odor, habitual in products derived from soy. Because of this odor, even when soy powder is used with other food, the food's original flavor is affected. This limits this application's range and amounts added as ingredients in nutrition. Although protein extracted from soy pie is frequently used for processed food, this application is also limited due to its unpleasant odor.

For example, the premature publication of Japanese Patent no 61-219347 [KOKAI], reveals a product decomposed from soy and its production method. This method consists of the stages of pulverizing soy, adding water to the pulverized soy to obtain a paste, heating it at a 60° C. to 100° C. temperature for a 5 to 180 minutes time period, homogenizing the heated paste under high pressure (100 to 800 kg/cm²), and hydrolyzing the resulting homogenized product with a neutral proteases (enzyme capable of breaking a peptides' bind between protein and peptide) produced by Bacillus subtitles. After, the resulting hydrolyzed product is heated and maintained for a time period necessary to inactivate enzyme action, it is dried by way of pulverization to obtain a product decomposed from this soy.

According to this method, all soy constituents can be used, and the digestion-absorption coefficient for human body can be ameliorated. However, once the soy cells are destroyed during pulverization stage and the homogenizing treatment executed under high pressure, there is still the unpleasant odor problem, habitual in products derived from soy, which remain in the decomposed product.

On the other hand, the premature publication of Japanese Patent no 8-89197 [KOKAI] reveals a method to produce processed soy food such as soymilk. This method consists of stages where water is added to soy, then soy is kept at room temperature for a required time period, a protopectinese is added to soy to obtain a mixture, then this mixture is maintained at room temperature (for example, 28° C.) for a long time period (for example, 8 hours) while agitating this mixture to achieve a treatment by enzyme, and then filtering the soy mixture to obtain soymilk.

According to this method, it is possible to separate soy cells from one another without destroying them. Each one of the isolated soy cells keeps a condition of involving nutrients such as proteins and fats through the cells' wall. Therefore, the unpleasant odor problem, characteristic in products derived from soy can be solved. However, the treatment by enzyme to separate soy cells from one another isn't necessarily enough. Initially, the enzymatic treatment mentioned above is performed at room temperature, however, the problem is having innumerous germs propagate themselves easily, which induces the occurrence of smell and blisters by fermentation. Besides this, since the required time period for enzymatic treatment is extremely long, there is still the problem that production efficiency is very little for industrial applications.

The present invention's method presents the following advantages compared to those foreseen in the technical state:

1. Due to the use of pectinase enzyme produced by microorganisms of the Aspergillus genera (such as pectinmethylesterase enzyme, produced by microorganism Aspergillus oryzae; or pectintranseliminase, polygalacturonase and pectinesterase enzymes, produced by microorganisms Aspergillus niger; or betagluconase (endo-1,3(4)-), produced by microorganism Aspergillus aculeatus), soy cells can be separated from one another in a short time period. Besides this, isolated soy cells present reduced damage to cells' membranes and cell walls, where protein and lipid are kept, in stable form, inside each of the isolated soy cells. Therefore obtaining very high quality isolated soy cells.

2. Once the enzymatic treatment is performed at a specific temperature, other than room temperature, it is possible to avoid propagation of several germs when compared to enzymatic treatment using enzyme produced by microorganisms of Rhizopus, Bacillus genera or similar. Therefore, the enzymatic treatment is advantageous in obtaining isolated fresh soy cells.

3. The pectinase enzyme produced by microorganisms from Aspergillus genera (such as pectinmethylesterase enzyme, produced by microorganism Aspergillus oryzae; or pectintranseliminase, polygalacturonase and pectinesterase enzymes, produced by microorganism Aspergillus niger; or betagluconase(endo-1,3(4)-), produced by microorganism Aspergillus aculeatus) has a better cost x benefit ratio when compared to enzymes used in the technical state.

4. With the addition of tocopherol, lipid oxidation (rancification) is prevented, contributing to obtain a better sensorial and nutritional quality product.

5. With the purpose of guaranteeing an ideal paste with hull particles of reduced size, which could compromise powder generation in the drying stage, soy paste is crushed in a crusher. This allows relevant nutrients contained in the soy grain hull and core to be maintained in the soy paste.

6. In the same manner, relevant nutrients contained in the soy grain hulls and cotyledon can be maintained in the soy paste through separation of soy grain hulls (for example, by dehulling machine), right before the washing stage. After separation, the hulls are sent to a mill which will reduce the size of its particles. The crushed hulls will be reincorporated afterwards to the paste, after inactivating enzymatic treatment.

### SUMMARY OF INVENTION

The present invention's main objective is to supply a method of processing soy by using a specific enzyme, which is, by using a pectinase produced by microorganisms of the Aspergillus genera (such as the pectinmethylesterase enzyme, produced by the microorganism Aspergillus oryzae; or the pectintranseliminase, polygalacturonase and pectinesterase enzymes, produced by the microorganism Aspergillus niger; or betagluconase(endo-1,3(4)-), produced by the microorganism Aspergillus aculeatus), which is capable of efficiently producing a processed soy powder and/or liquid with substantially no unpleasant odor whatsoever, characteristic of products derived from soy, and an improved digestion-absorption coefficient for human body, using soy in its integral form, in other words, utilizing all nutrients present in soy.

A second objective of the present invention is to supply a processed soy powder and/or liquid with substantially no unpleasant odor, characteristic of products derived from soy and an improved digestion-absorption coefficient for human body, using soy in its integral.

### BRIEF DESCRIPTION OF DRAFTS

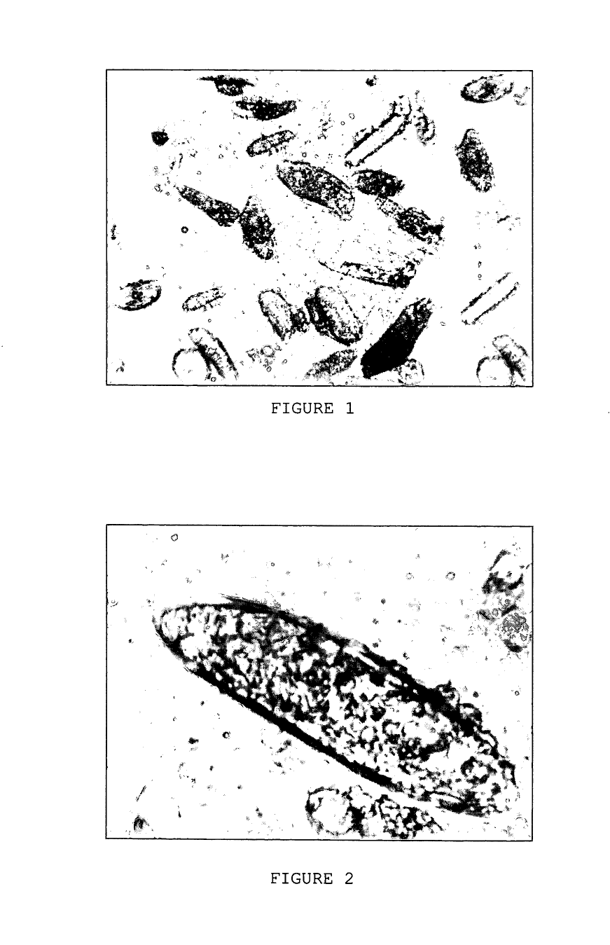

FIG. 1 is an optic microscopic photograph (10× Eyepiece/10× Objective Lens=100× Magnification) from soy powder reconstructed in water, obtained by soy processing method according to the present invention.

FIG. 2 is an optic microscopic photograph (10× Eyepiece/10× Objective Lens=100× Magnification) from soy powder reconstructed in water, obtained by soy processing method according to the present invention.

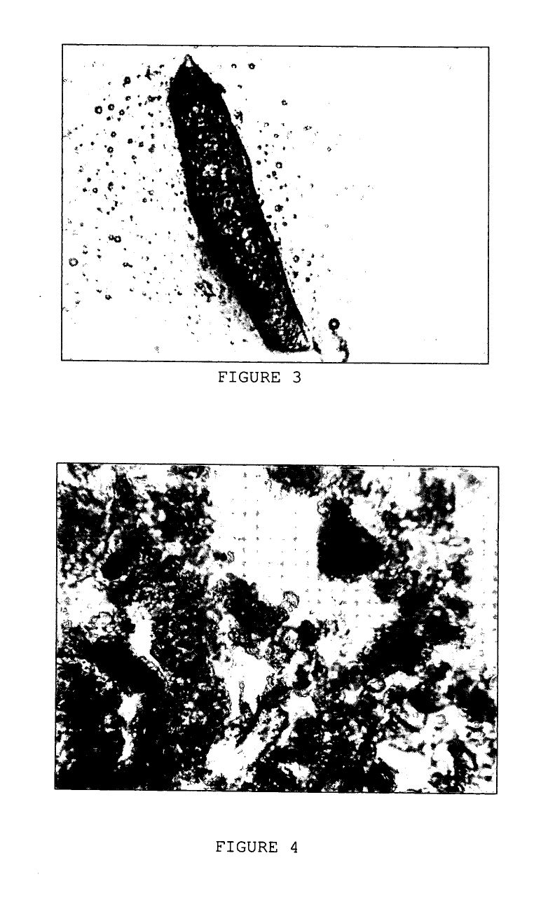

FIG. 3 is an optic microscopic photograph (10× Eyepiece/10× objective Lens=100× Magnification ) from soy powder reconstructed in water, obtained by soy processing method according to the present invention.

FIG. 4 is an optic microscopic photograph (10× objective Lens=100× Magnification ) from integral soy flour reconstructed in water, obtained by soy processing conventional methods.

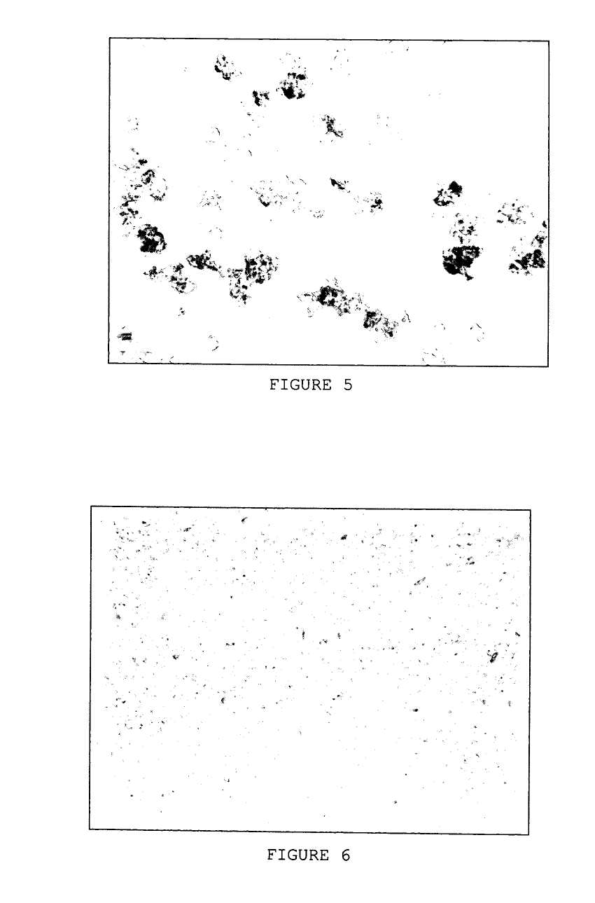

FIG. 5 is an optic microscopic photograph (10× Eyepiece/10× Objective Lens=100× magnification) from integral soy flour reconstructed in water, obtained by conventional soy processing methods.

FIG. 6 is an optic microscopic photograph (10× Eyepiece/10× Objective Lens=100× Magnification ) of beverage derived from isolated protein from soy.

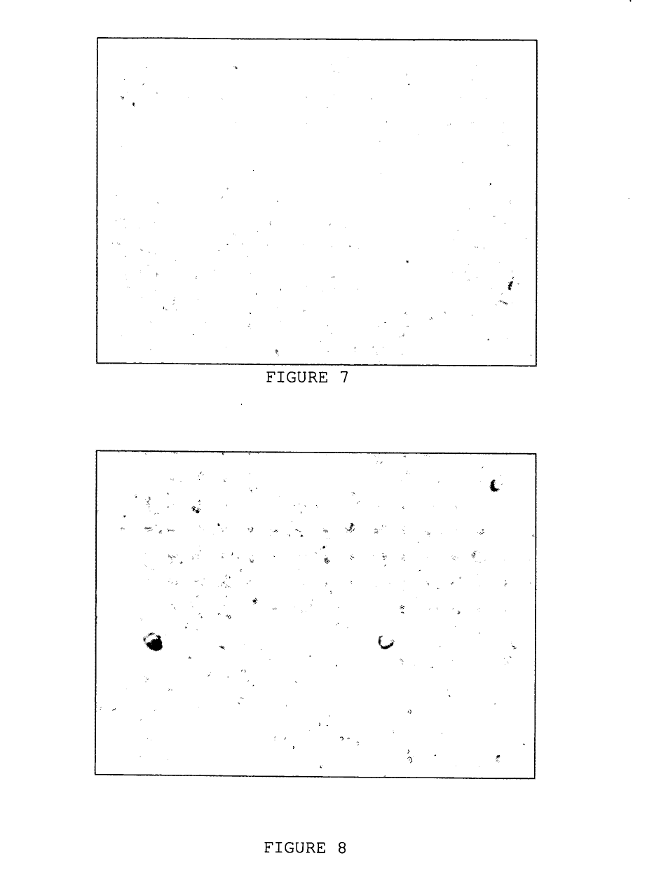

FIG. 7 is an optic microscopic photograph (10× Eyepiece/10× Objective Lens=100× Magnification ) of beverage derived from soy extract.

FIG. 8 is an optic microscopic photograph (10× Eyepiece/10× Objective Lens=100× Magnification) of soy germ.

### INVENTION DETAILED DESCRIPTION

Bellow a detailed description of the soy processing method using enzymes according to the present invention.

Initially, a predetermined amount of soy is washed with running water, using a grains washer, and then immersed in water. The washing stage can also be performed with water vapor passing grains through a transporter screw located inside a tube that receives vapor injection through orifices positioned along its length. This resource is used in cases where soy is very dark due to soil pigments that are bound to its hull. Water vapor washing will remove residual soil pigments and, consequently it will lighten the color of soy hull, lighting also, the color of paste and powder.

The water immersion stage is performed to supply a sufficient amount of water inside individual soy cells, so that a posterior treatment by enzyme becomes easier to be performed. This stage can be performed at a 40° C. to 80° C. temperature, during a 2 to 6 hours time period, preferably at a 60° C. temperature for a 4 hours time period.

If necessary, water containing a small amount of enzymes used in the enzymatic treatment, to be described later, can be used in the immersion stage.

Afterwards, soy is boiled in the presence of water. This decoction stage is performed to inactivate lipoxigenase (enzyme contained in soy), and ameliorate the digestion-absorption coefficient for human body by thermal denaturizing of soy anti-nutritional factors. Besides this, this stage softens soy intracellular substance, so that the enzymatic treatment becomes easier to be executed. This decoction stage is executed by pressure. Decoction by pressure can be executed from 110° C. to 130° C. and for a 10 to 30 minutes time period, preferably at a 120° C. temperature and for a 20 minutes time period, by using a Reactor. The pressure used is around 0.05 MPa to 0.25 MPa, preferably 0.1 MPa.

After decoction, cutting stage follows. With the purpose of reducing the size of particles, augmenting its superficial surface, boiled soy is then, cut by a crusher. This stage of the process is important in order to perform a more efficient enzymatic treatment.

Optionally, tocopherol can be added to the soy paste with the purpose of preventing soy fatty oxidation. The amount of tocopherol to be used can vary from 100 to 400 ppm of tocopherol by soy fatty content. Tocopherol, still, can be added to water from immersion stage and, still, after the enzymatic treatment.

In the subsequent stage, cooling at a specific temperature is executed, which depends on the enzyme that will be used. After cooling, addition of water and specific enzyme produced by microorganisms of the Aspergillus genus occurs.

In the present invention, the enzyme used in the enzymatic treatment is a pectinase, produced by microorganisms of the Aspergillus genus. After soy has been cooled to a specific temperature, water and pectinase are added to soy to obtain a mixture. Soy is cooled at a 30° C. to 70° C. temperature.

In order to avoid soy constituent's loss, proteins for example, it is used preferably, residual water from the immersion stage of the enzymatic treatment. It is also preferred that the amount of water added should be substantially equal to soy's weight before the enzymatic treatment. The amount of pectinase to be added is around 0.05% to 0.5% of soy weight before the immersion stage.

The mixture is kept, at a 30 to 70° C. temperature for a 10 to 60 minutes time period, while it is being agitated to reach the enzymatic treatment. Additionally, once pectinase shows high enzymatic activity around pH from 3.5 to 7.0, it is possible to perform enzymatic treatment without using a blocking agent.

During enzymatic treatment, pectinase efficiently acts on protopectine, which is pectin that binds soy cells among each other, so that soy cells can be efficiently separated from one another without destroying its walls.

In a concretization of the present invention, pectinase used in the enzymatic treatment is pectinmethylesterase, produced by microorganism Aspergillus oryzae. After soy has been cooled to a specific temperature, water and pectinmethylesterase are added to soy to obtain a mixture. Soy is cooled at a 30° C. to 60 ° C. temperature, preferably at 40° C.

In order to avoid soy constituents' loss, proteins for example, it is used preferably, residual water from the immersion stage of enzymatic treatment. It is also preferred that the amount of water added be substantially equal to soy weight before enzymatic treatment. The amount of pectinmethylesterase to be added is around 1 to 3 ml per soy kg, preferably the amount of pectinmethylesterase to be added is 2 ml per soy kg.

The mixture is maintained, at a 30 to 60° C. temperature for a 10 to 40 minutes time period, preferably at 40° C. temperature for a 30 minutes time period, while it is being agitated to achieve enzymatic treatment. From the preliminary experiments, it was confirmed that a maximum activity of pectinmethylesterase enzyme is obtained at 40° C. Additionally, once pectinmethylesterase shows elevated enzymatic activity around pH from 3.5 to 7.0, preferably 6.0 to 7.0, it is possible to perform enzymatic treatment without using a blocking agent.

In another concretization of the present invention specific enzymes used in the enzymatic treatment are pectintranseliminase, polygalacturonase and pectinesterase, produced by microorganism Aspergillus Niger. After soy has been cooled to a specific temperature, water and pectintranseliminase, polygalacturonase and pectinesterase are added to soy to obtain a mixture. Soy is cooled at a 40° C. to 65° C. temperature, preferably at 55° C.

In order to avoid soy constituent loss, protein for example, it is used preferably, residual water from the enzymatic treatment immersion stage. It is also preferred that amount of water added should be substantially equal to soy's weight before the enzymatic treatment. The amount of pectintranseliminase, polygalacturonase and pectinesterase to be added is around 0.2 to 2 ml per L of paste, preferably the amount of pectintranseliminase, polygalacturonase and pectinesterase to be added is 0.5 ml per L of paste.

The mixture is maintained, at a 40 to 65° C. temperature for a 15 to 45 minutes time period, preferably at a 55° C. temperature for a 30 minutes time period, while it is being agitated to achieve enzymatic treatment. From the preliminary experiments, it was confirmed that the maximum activity of enzymes pectintranseliminase, polygalacturonase and pectinesterase is obtained at 55° C. Additionally, once pectintranseliminase, polygalacturonase and pectinesterase show elevated enzymatic activity around pH 3.5 to 7.0, preferably 4.5.

Still in another concretization of the present invention the specific enzyme used in the enzymatic treatment is beta-gluconase(endo-1,3(4)-), produced by the microorganism Aspergillus aculeatus. After soy has been cooled to a specific temperature, water and beta-gluconase(endo-1,3(4)-) are added to soy to achieve a mixture. Soy is cooled at a 30° C. to 60° C. temperature, preferably 40° C.

In order to avoid loss of soy constituents, proteins for example, residual water from the immersion stage of the enzymatic treatment is used. It is also preferred that the amount of water added be substantially equal to soy weight before the enzymatic treatment. The amount of beta-gluconase(endo-1.3(4)-) to be added is around 0,03% to 0.5% in soy weight measured before the immersion stage, preferably to the amount of beta-gluconase(endo-1,3(4)-) to be added is 0.036% of soy weight.

The mixture is maintained, at a 30 to 60 ° C. temperature for a 15 to 45 minutes time period, preferably at a 40° C. temperature for a 30 minutes time period, while it is being mixed to achieve enzymatic treatment. From the preliminary experiments, it was confirmed that a maximum activity of the beta-gluconase(endo-1,3(4)-) enzyme is achieved at 40° C. Additionally, once beta-gluconase(endo-1,3(4)-) shows elevated enzymatic activity around pH from 3.5 to 7.0, preferably 6.5, it is possible to perform an enzymatic treatment without using a blocking agent.

During the treatment by enzyme, pectinases act efficiently on protopectine, which is a pectin that binds soy cells among themselves, so that soy cells can be efficiently separated from one another without destroying its walls.

In order to accelerate enzymatic action in any of the three concretizations of the present invention referred to above, pH can be reduced using organic acids, such as citric acid or acetic acid.

The agitation operation must be performed so that soy cells are not destroyed. It is preferred to select a tender agitation condition in which agitators agitate the mixture at a 20 rpm to 30 rpm frequency. Such agitation allows the specific enzyme to act evenly in soy cells, and smoothly separate soy cells from one another through agitators. The result of the enzymatic treatment is the acquisition of a paste, in which isolated soy cells are dispersed.

Next, a heat treatment is performed on the paste to inactivate the action of the specific enzyme. Preferably, the paste is heated at around 95° C. for 12 seconds.

Since the hull and core are parts of the soy, which are relevant nutrient sources (such as, fibers, minerals and isoflavones) it is important to keep them in the soy paste. With the purpose of guaranteeing an ideal paste and reducing the size of hull particles, avoiding any residual larger particle, which could compromise powder formation in the drying stage, soy paste is crushed in a crusher.

An alternative stage to the stage of triturating soy paste described above, would be separation of soy hulls, right before the washing stage. After separation the hulls are sent to a mill, which will reduce the size of these particles. The crushed hulls will be reincorporated afterwards to the paste, right after enzymatic treatment.

Optionally, in case it is intended to obtain soy paste (and, subsequently, soy powder) in a lighter color, a calcium source can be added, such as, calcium carbonate and/or tricalcium phosphate in an amount which, the total amount of calcium salt in powder, is between 1 and 3% of soy weight, preferably, 2% in soy weight.

The paste obtained is dried by pulverization drying method (spray-drying). In this drying stage a “spray dryer” is used. The incoming air temperature in the “spray dryer” is 190 to 210° C. and the outgoing air temperature is 95 to 105° C., with 20˜35 mm.Hg induced fan.

In case processed soy powder is used directly as nutritional supplement, for example when added to beverages and other liquids prepared by the user, an optional stage of the process can be included in order to ameliorate soy powder solubility. Powder is processed in a pelletiser, which is equipment that leaves powder in suspension through an air flow system. By pulverizing water through the top, the particles are agglomerated forming small granules. Besides this, air flow also serves to dry the particles that received water in this process, resulting therefore, in small granules, agglomerated powder particles which are very soluble in liquid food.

Alternatively, with the purpose of processing liquid soy, immediately after the enzymatic action inactivation stage, it is possible to obtain a paste, in which the isolated soy cells are dispersed. This paste can be used as processed liquid soy. It has a notable characteristic, due to the fact that soy cells aren't destroyed even when the paste is frozen and defrosted afterwards, or even when paste suffers sterilization, for example at 120° C. for 20 minutes.

When processed soy powder or liquid is acquired by the present invention's processing method it is possible to use it as an ingredient in several types of foods, whether conventional or specific foods. As described previously, soy is a highly, nutritious food, which is rich in proteins with highly nutritional value, fibers, some vitamins and minerals, besides having an excellent lipid profile. Therefore, it is expected that processed soy powder and liquid should be used in formulations specifically developed for groups of individuals that have specific nutritional needs, as for example, children, adolescents, women, athletes, elder and individuals who need to treat or prevent certain pathologies (for example: cardiovascular diseases, diabetes, obesities, osteoporoses, etc). Soy powder is more convenient to transport than processed soy liquid, since processed soy powder is lighter. Additionally, another advantage of processed soy powder is that it can easily be transformed in liquid food by simply adding water or other liquids.

Despite its high nutritional value, the use of soy in food has been limited due to its unpleasant odor, peculiar to food, which contains it. However, since processed soy powder or liquid by the method proposed in the present invention has an ameliorated digestion-absorption coefficient for the human body and all characteristic soy odors has disappeared, it is possible to use processed soy powder or liquid along with lots of other food. For example, it is possible to use processed soy powder or liquid using the method of the present invention in food such as cereal bars, nutritious beverages (in powder or ready for usage), milk substitutes (in powder or ready for usage), extrusive salty food, extrusive cereal flakes, cookies (sweet and salty), chocolates, breads, cakes, pasta in general and soups, without unpleasant olfactory perception peculiar to soy.

According to the method explained above, processed soy powder from the present invention can be produced. Optical microscopic photographs of processed soy powder according to the process of the present invention are shown on FIGS. 1, 2 and 3.

In FIG. 1 it is possible to observe several incorrupt soy cells, with its intact membranes and its intracellular contents preserved. The membrane's integrity minimizes lipid oxidation—main responsible for soy's unpleasant odor. Intact cells keep protein and other nutrients inside, as if encapsulated. This way, product deterioration is delayed and water is maintained inside the cells.

In FIGS. 2 and 3 it is possible to observe an incorrupt soy cell, with its intact membrane and preservation of intracellular content.

In FIG. 4 it is possible to observe an image of a camp containing innumerous cell fragments. There was rupture and liberation of intracellular content, this way favoring rancid odor and flavor—unpleasant.

In FIG. 5 it is possible to observe bursting of membranes and consequent liberation of intracellular content.

In FIGS. 6, 7 and 8 it is possible to observe absence of uncorrupt cells, and it is possible to visualize only their fragments.

### EXAMPLES

The present invention is described bellow referring to its preferred modality.

### Example 1

1000 kg of dry soy grains were washed with running water using a grain washer. In a reactor, 3000 L of treated water were added. 135 g of hydro soluble powder tocopherol with 30% pureness were dissolved, in 1 L of water, and afterwards, this solution was added to the reactor's water. The present solution was heated in the reactor up to 60° C. and soy grains were added, leaving them for 4 hours. From then on, the grain decoction stage was started at a 0.1 MPa pressure at 120° C. for 20 minutes. The grains were then cooled down to 40° C. The grains were passed through a crusher in order to be cut, this way, reducing the size of the particles. This soy paste was stored in a lined tank with a low rotation agitator (20 rpm) to begin the enzymatic treatment. 1 L of soy paste was removed and diluted in 10 g of lipo soluble liquid tocopherol with 70% purity. The new solution was then, added to the soy paste. 2 L of pectinmethylesterase enzyme were added to the initial soy paste, which was kept at 40° C. in slow agitation of 20 rpm for 30 minutes. In order to inactivate the enzyme, temperature was raised to 95° C. for 12 seconds. Then the paste was cooled down to 70° C. and was passed through a crusher. 20 kg of calcium carbonate were added previously diluted in 100 L of water. The paste was directed to a lung tank were it received an addition of 10 g of lipo soluble liquid tocopherol with 70% purity diluted in 1 L of the paste.

The final paste then passed by a “spray-dryer” transforming itself in powder.

1. Soy processing method by use of specific enzyme characterized by the fact that it encompasses the following stages:
a) washing of soy grains;
b) immersion of soy in water at a specific temperature;
c) decoction by pressure of soy in water;
d) cutting of soy grains;
e) cooling of cut soy obtained in stage d);
f) enzymatic treatment executed by adding water and a pectinase produced by microorganisms of Aspergillus genera to cut soy forming a mixture, maintaining the mixture at a specific temperature and specific ph, for a predetermined time while the referred mixture is agitated in low rotation;
g) inactivation of pectinase, by heating the paste obtained in stage f); and
h) triturating soy paste through a crusher to obtain liquid processed soy.

2. Method, according to claim 1, wherein the washing stage of soy grains is executed with running water using a grains washer.

3. Method, according to claim 1, wherein the immersion stage is performed immerging soy grains at a 40° C. to 80° C. temperature for a 2 to 6 hours time period.

4. Method, according to claim 1, wherein the decoction stage is performed in a Reactor at a 110° C. to 130° C. temperature, at a 0,05 MPa to 0,25 Mpa pressure, for a 10 to 30 minutes time period.

5. Method, according to claim 1, wherein the cutting stage of soy grains is performed by a crusher.

6. Method, according to claim 1, which further comprises a stage where tocopherol is added to soy after stage d).

7. Method, according to claim 1, which further comprises a stage of addition of tocopherol to water from the immersion stage.

8. Method, according to claim 1, which further comprises a stage of addition of tocopherol after enzymatic treatment stage.

9. Method, according to claim 6, wherein the amount of tocopherol varies from 100 to 400 ppm.

10. Method, according to claim 1, wherein the cooling stage is performed at a temperature depending on specific pectinase.

11. Method, according to claim 1, wherein in the enzymatic treatment stage, the water added is preferably residual water from the immersion stage.

12. Method, according to claim 1, wherein in the enzymatic treatment stage, pectinase used is pectinmethylesterase produced from the microorganism Aspergillus oryzae, where the temperature is maintained at around 30° C. to 60° C. at a pH from 3,5 to 7,0 for a 10 to 40 minutes time period.

13. Method, according to claim 12, wherein the amount of pectinmethylesterase added is 1 to 3 ml per kg of soy.

14. Method, according to claim 1, wherein in the enzymatic treatment stage pectinase used is pectintranseliminase, polygalacturonase and pectinesterase produced from the microorganism Aspergillus niger, where the temperature is maintained at around 40° C. to 65° C. at a pH 3,5 to 7,0 for a 15 to 45 minutes time period.

15. Method, according to claim 14, wherein the amount of pectintranseliminase, polygalacturonase and pectinesterase added is 0,2 to 2 ml per L of paste.

16. Method, according to claim 1, wherein the enzymatic treatment stage the pectinase used is beta-gluconase (endo-1,3(4)-) produced by the microorganism Aspergillus aculeatus, where the temperature is maintained at around 30° C. to 60° C. at a pH from 3,5 to 7,0 for a 15 to 45 minutes time period.

17. Method, according to claim 16, wherein the amount of beta-gluconase(endo-1,3(4)-) added is 0,03% to 0,5% in soy weight measured before the immersion stage.

18. Method, according to claim 1, wherein the agitation of the mixture in the enzymatic treatment stage occurs at a 20 to 30 rpm frequency.

19. Method, according to claim 1, wherein in the inactivation stage, the paste is heated at around 95° C. for 12 seconds.

20. Method, according to claim 1, which further comprises a stage of adding a calcium source after stage h).

21. Method, according to claim 20, wherein the calcium source encompasses calcium carbonate, tricalcium phosphate or its mixtures.

22. Method, according to claim 21, wherein the total amount of powdered calcium salts is around 1 to 3% in soy weight.

23. Method, according to claim 1, which further comprises a stage i) after the stage h) for drying crushed soy paste to obtain processed soy powder.

24. Method, according to claim 23, wherein in the drying stage, the method used is drying by pulverization (spray-drying) where a “spray-dryer” is used.

25. Method, according to claim 24, wherein in the drying stage, the incoming air temperature in the “spray dryer” is 190 to 210° C. and the outgoing air temperature is 95 to 105° C., with 20˜35 mm Hg induced fan.

26. Method, according to claim 24, which further comprises a granulation stage of processed soy powder after the stage i).

27. Method, according to claim 26, wherein in the granulation stage, the processed soy powder is processed in a pelletiser, which is an equipment that leaves the powder in suspension through an air flow system; by pulverization of water from the top, the particles are agglomerated forming small granules; and, besides this, the air flow also dries the particles that received water in this process, resulting therefore in small granules, agglomerated powder particles, which are very soluble in liquid food.

28. Soy processing method using specific enzyme characterized by the fact that it encompasses the following stages:
a) separation of soy grains hulls;
b) triturating of the hulls;
c) washing of soy grains;
d) immersion of soy in water at a specific temperature;
e) decoction by pressurizing soy in water;
f) cutting of soy grains;
g) cooling of cut soy obtained in stage e);
h) enzymatic treatment performed by adding water and a pectinase produced by microorganisms of the Aspergillus genus to cut soy forming a mixture, maintenance of mixture at a specific temperature and specific pH, for a predetermined time period while the referred mixture is agitated in low rotation;
i) inactivation of pectinase, by heating the paste obtained in stage h);
j) incorporation of crushed hulls arising from stage b) to the paste; and
k) triturating soy paste through a crusher to obtain liquid processed soy.

29. Method, according to claim 28, wherein the separation stage of soy grains hulls is performed through a dehulling machine.

30. Method, according to claim 28, wherein the triturating stage is performed in a mill.

31. Method, according to claim 28, wherein the washing stage of soy grains is performed with running water using a grains washer.

32. Method, according to claim 28, wherein the immersion stage is performed immerging soy grains at a 40° C. to 80° C. temperature for a 2 to 6 hours time period.

33. Method, according to claim 28, wherein the decoction stage is performed in a Reactor at a 110° C. to 130° C. temperature, at a 0,05 MPa to 0,25 Mpa pressure, for a 10 to 30 minutes time period.

34. Method, according to claim 28, wherein the cutting stage of soy grains is performed by a crusher.

35. Method, according to claim 28, which further comprises a stage of adding tocopherol to soy after stage f).

36. Method, according to claim 28, which further comprises adding tocopherol to the water of the immersion stage.

37. Method, according to claim 28, which further comprises adding tocopherol after enzymatic treatment stage.

38. Method, according to claim 36, wherein the amount of tocopherol varies from 100 to 400 ppm.

39. Method, according to claim 28, wherein the cooling stage is performed at a temperature depending on specific pectinase.

40. Method, according to claim 28, wherein in the enzymatic treatment stage, the water added is preferably residual water from the immersion stage.

41. Method, according to claim 28, wherein in the enzymatic treatment stage, the pectinase used is pectinmethylesterase produced from the microorganism Aspergillus oryzae, where the temperature is maintained around 30° C. to 60° C. at a pH 3,5 to 7,0 for a 10 to 40 minutes time period.

42. Method, according to claim 41, wherein the amount of pectinmethylesterase added is from 1 to 3 ml per kg of soy.

43. Method, according to claim 28, wherein in the enzymatic treatment stage, the pectinase used is pectintranseliminase, polygalacturonase and pectinesterase produced from the microorganism Aspergillus niger, where the temperature is maintained around 40° C. to 65° C. at a pH from 3,5 to 7,0 for a 15 to 45 minutes time period.

44. Method, according to claim 43, wherein the amount of pectintranseliminase, polygalacturonase and pectinesterase added is 0,2 to 2 ml per L of paste.

45. Method, according to claim 28, wherein in the enzymatic treatment stage, the pectinase used is beta-gluconase (endo-1,3(4)-) produced from the microorganism Aspergillus aculeatus, where the temperature is maintained around 30° C. to 60° C. at a pH 3,5 to 7,0 for a 15 to 45 minutes time period.

46. Method, according to claim 45, wherein the amount of beta-gluconase (endo-1,3(4)-) added is 0,03% to 0,5% in soy weight measured before the immersion stage.

47. Method, according to claim 28, wherein the agitation of the mixture in the enzymatic treatment stage occurs at a 20 to 30 rpm frequency.

48. Method, according to claim 28, wherein in the inactivation stage, the paste is heated at around 95° C. for 12 seconds.

49. Method, according to claim 28, characterized by the fact that incorporation of crushed hulls to the inactivated paste.

50. Method, according to claim 28, which further comprises a stage of adding a calcium source after stage k).

51. Method, according to claim 50, wherein the calcium source encompasses calcium carbonate, tricalcium phosphate or its mixtures.

52. Method, according to claim 51, wherein the amount of powdered calcium salts is around 1 to 3% of soy weight.

53. Method, according to claim 52, which further comprises a stage l) after the stage k) for drying of soy paste to obtain processed soy powder.

54. Method, according to claim 53, wherein in the drying stage the method used is drying by pulverization (spray-drying) where a “spray-dryer” is used.

55. Method, according to claim 54, wherein in the drying stage, the incoming air temperature in the “spray dryer” is 190 to 210° C. and the outgoing air temperature 95 to 105° C., with 20˜35 mm Hg induced fan.

56. Method, according to claim 53, which further comprises a granulation stage of processed soy powder after stage l).

57. Method, according to claim 56, wherein in granulation stage, the processed soy powder is processed in a granulator which is an equipment that leaves the powder in suspension through an air flow system; by pulverizing water through the top, the particles are agglomerated forming small granules; and, besides this, the air flow also dries the particles that received water in this process, resulting therefore, in small granules, agglomerated powder particles, which are very soluble in liquid food.
